(19) United States
(12) Patent Application Publication
(10) Pub. No.: US 2013/0332212 A1
(43) Pub. Date: Dec. 12, 2013

(54) METHODS AND SYSTEMS FOR DEVELOPING AN OPTIMISED OPERATIONAL SYSTEM IN A NETWORK

(71) Applicant: Alon COHEN, Tenafly, NJ (US)

(72) Inventor: Alon COHEN, Tenafly, NJ (US)

(21) Appl. No.: 13/489,941

(22) Filed: Jun. 6, 2012

(51) Int. Cl. G06Q 10/06

(52) U.S. Cl. 705/7.15; 705/7.13; 705/7.16

(57) ABSTRACT

Embodiments of the present disclosure provide methods and systems for developing an optimized operational system in a network. The method includes: defining a project along with its domain and at least one set of formal development rules related to its domain with assistance from multiple users; decomposing the project into multiple tasks in a recursive up-down process with the assistance from the users, each of the tasks includes a task definition language, an associated test task, and multiple rules; publishing the multiple tasks along with their associated payment offer in the network; allocating the tasks to a number of participants based on a predefined criteria; and integrating a number of operational components into the operational system by using a recursive down-up integration process. The operational components are developed, by the participants, by completing the allocated tasks and testing each of the multiple tasks.

### FIELD OF THE INVENTION

The present invention is related to operational system or software development and more specifically to methods and systems for developing an optimized operational system or project by distributing the development effort among a plurality of developers in a network.

### BACKGROUND OF THE INVENTION

A software development life cycle includes a number of methodologies for developing information systems or software products. These methodologies form the framework for planning and controlling the creation of an information system. A software development methodology can be simply defined as a set of procedures that one follows from the beginning to the completion of the software development process. The nature of the methodology is dependent on a number of factors, including the software development environment, the organization's practices, the nature or type of the software being developed, the requirements of the users, the qualification and training of the software development team, the available hardware and software resources, the availability of existing design modules, and even the budget and the time schedule.

There are different types of methodology for resolving different types of problems or classes of problems. The problems of similar characteristics can be grouped together to form a problem domain. Specific methodologies are often developed to be applied or to resolve certain “classes” of problems, also called the domain of the application.

Existing design methodologies are divided into two broad categories: the systematic and the formal types. The formal type methodologies make extensive use of mathematical notations for the object transformations and for checking consistencies. The systematic type methodologies are less mathematical and consist of the procedural component, which describe what action or task to perform and the representation component, which describes how the software structure should be represented. Generally, techniques from the systematic design methodologies can be integrated and can utilize representations schemes from other techniques when it is appropriate. Existing software development methodology suffers from many limitations such as, when there is a need for iterative development (e.g. web development or e-commerce) then stakeholders need to review on a regular basis the software being designed. Also, as the complexity and size of a software product/system increases the effort, time and cost to develop it also increases. In addition, it becomes too hard to estimate costs because of huge size of the software product/system. The existing reliability-assurance models for developing software are so expensive that they are usually being implemented only in the defense, aviation, and aerospace domains for Avionics of all sorts.

U.S. Pat. No. 7,257,804 issued to Accenture Global Service GmbH discloses a method of producing a software product. The method disclosed in this patent produces a software product by defining a functional model of the overall software product designing, based on this functional model, a plurality n slices of the software product, a slice is a set of functions of the software product constructed together and forming the entirety or part of a configuration. US patent application number 20080196004 issued to Samsung Electronics Co. Ltd. Discloses an apparatus and method for developing component based software. The disclosed apparatus and method develops component-based software in order to define an identified component in a component language and reuse the identified component. The existing methods allow achievement of a highly efficient use of resources within a short development time and reuse of component but they still suffer from limitations as the different slices or components are not properly tested before integration. This may lead to bugs in the system. Therefore, existing methodologies and systems do not guarantee a reliable software product.

In light of the above discussion, systems and methods are desired for developing optimized operational systems in a network to shorten development cycle and effort required to develop the operational systems, with much higher reliability.

### SUMMARY

Embodiments of the invention provide a system and method for developing an optimized operational system in a network. An embodiment may include defining a project along with a domain of the project and at least one set of formal development rules related to the domain of the project with assistance from one or more users. An embodiment may include decomposing or dividing the defined project into multiple tasks in a recursive up-down process with the assistance from the one or more users. Each of the tasks includes a task definition language, an associated test task, and a number of rules. An embodiment may include publishing the tasks along with a payment offer associated with each of the tasks in the network. An embodiment may include offering, allocating, dividing up and/or distributing the multiple tasks to a number of participants in the network based on one or more predefined criteria. An embodiment may include integrating a number of operational components into the operational system by using a recursive down-up integration process. The operational components are developed, by the participants, by completing the allocated tasks and testing each of these tasks.

In one embodiment, the task may be offered to more than one of a plurality of participants, and only the task first completed and fully tested is accepted.

The task may be considered as complete in one embodiment only when the task has passed the test based on the associated test task, where an outcome of a completed task is one of the operational components.

Embodiments of the invention also provide a system and method for developing an operational system with the help of a number of participants in a network. The method includes defining a project along with a domain of the project and at least one set of formal development rules related to the domain of the project. The one or more users define the project in a language understandable by at least one of the participants or the users. The method further includes decomposing the defined project into a number of tasks in a recursive up-down process with the assistance from the one or more users. Each of the tasks includes a task definition language, an associated test task, and a number of rules. The project is decomposed such that each of the tasks is too small to be decomposed further based on at least one of the task definition language and the rules. The method also includes publishing the tasks along with a payment offer associated with each of the tasks through a website in the network. Further, the method includes inviting price auctions, from the participants, for performing the tasks. Furthermore, the method includes allocating these tasks to participants in the network based on at least one or more predefined criteria and the received price auctions. The method further includes integrating a number of operational components into the operational system by using a recursive down-up integration process. The operational components are developed, by the participants, by completing the allocated tasks and testing each of the tasks.

Embodiments of the invention also provide a system and method for developing an optimized operational system in a network. The system includes a project definition module configured to define a project along with a domain of the project and at least one set of formal development rules related to the domain of the project with assistance from one or more users. The system also includes a task decomposition module configured to decompose the defined project into a number of tasks in a recursive up-down process with the assistance from the one or more users. Each of the tasks includes at least one of a task definition language, at least one associated test task, and a number of rules. The system further includes a task publishing module configured to publish a number of tasks along with a payment offer associated with each of these tasks in the network. The system also includes a task allocation module configured to allocate the tasks to a number of participants in the network based one or more predefined criteria. Further, the system includes an integration module configured to integrate a number of operational components into the operational system by using a recursive down-up integration process. The operational components are developed, by the participants, by completing the allocated tasks and testing each of the tasks.

In one embodiment, payments may be managed. For example, a method and system may manage one or more payments corresponding to the plurality of tasks based on visualization and verification of the plurality of tasks, where the one or more payments are done by using conventional payment methods comprising for example a credit card, a debit card, net-banking, ACH, cash cards, pay-pal or other available payment methods.

One embodiment may included visualizing the progress of the plurality of the tasks based on a status of each of the plurality of tasks, where the status depicts the current condition of the task, tracking the progress of at least one of project development, project decomposition and project integration based on the visualization of the progress of the plurality of tasks, verifying that a task of the plurality of tasks is allocated to only one of the plurality of participants until the task is complete or returned incomplete from the one participant, and changing the payment offer of one or more of the plurality of tasks for at least one of expediting or slowing down the development of the one or more tasks of the project depending on an expected completion date of the project.

An embodiment may include publishing the plurality of tasks by, for example, publishing the plurality of tasks through a web site in the network, and conducting or inviting one or more price auctions from the plurality of participants, for performing the plurality of tasks.

An embodiment may include a system, method or task allocation module allocating the tasks with the assistance or input from the participants, where each of the participants selects at least one task that the participant wants to perform, where the at least one task is allocated to the participant, and is locked until the at least one task is complete or the participant relinquishes control from the at least one task. The task may be considered or marked as complete only when the task has passed the test based on the associated test task, where an outcome of a completed task is one of the operational components. The project may be defined in a language understandable by at least one of the plurality of participants or the one or more users.

### BRIEF DESCRIPTION OF THE DRAWINGS

Having thus described the invention in general terms, reference will now be made to the accompanying drawings, which are not necessarily drawn to scale, and wherein:

FIG. 1A illustrates an exemplary environment, in accordance with an embodiment of the invention;

FIG. 1B shows another exemplary environment, in accordance with an embodiment of the present disclosure;

FIG. 2 illustrates exemplary components of the operation system developing system, in accordance with an embodiment of the present disclosure;

FIG. 3 illustrates a recursive process of task decomposition and integration for a software development project, in accordance with an embodiment of the present disclosure;

FIG. 4 illustrates an exemplary huge puzzle creation project, in accordance with an embodiment of the present disclosure;

FIGS. 5A, 5B, and 5C illustrate a flowchart for developing an optimized operational system, in accordance with an embodiment of the present disclosure; and

FIG. 6 is a schematic illustration of a system according to an embodiment of the present disclosure.

### DETAILED DESCRIPTION OF THE INVENTION

Illustrative embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

An embodiment of the present invention provides a new methodology designed to enable large groups of programmers and testers to work in parallel, thus shrinking the software development cycle. The disclosed methodology may well be implemented for other fields of engineering. The present disclosure defines some guidelines for a methodology with a new set of characteristic designed to enable distributed fast and reliable software development. The disclosed method distributes the development effort of an engineering task such as software development or an operational system development, among hundreds, thousands, or even larger number of programmers, to shorten development cycle to a fraction of what can be achieved today, and with much higher reliability.

Embodiments of the disclosed methods include providing a functional definition of any project such as software program, decomposing or dividing it into sub programming, design and testing tasks, then recursively repeating the process involving more and more participants, until it is divided to sufficiently small tasks or elements that are easy to program and test. Then integrating or re-combining the tasks, reversing said decomposing process using a down-up process to create the operational system. The operational system can be a software system/product.

Embodiments of the disclosed methods and systems may be used for different types of engineering or software development projects and also for projects such as, but are not limited to, puzzle creation, movie script writing and any large projects that can be divided into smaller tasks that may later be re-composed to one bigger project.

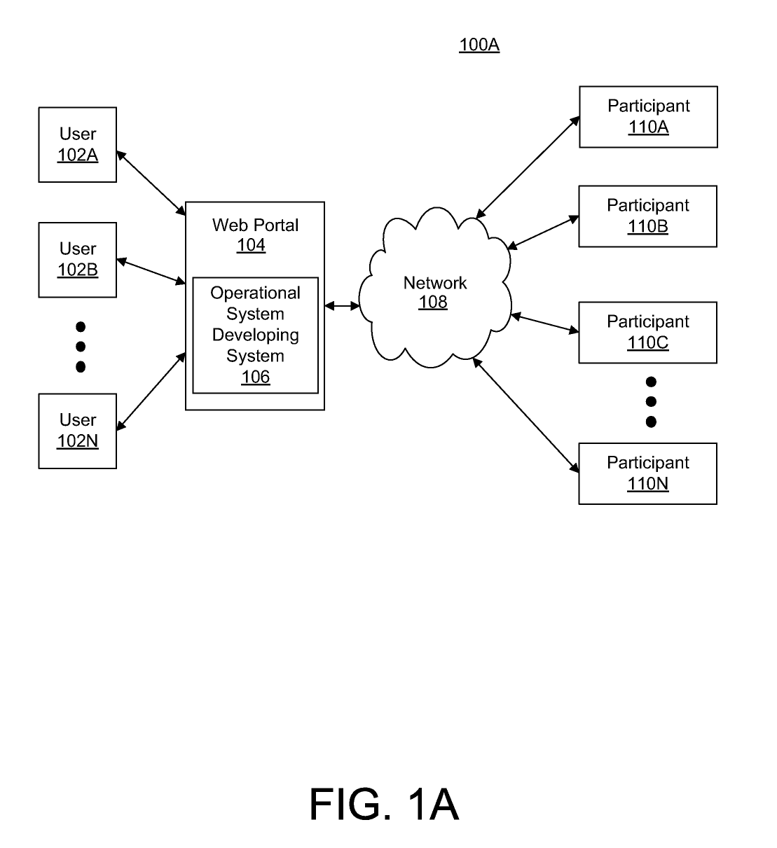

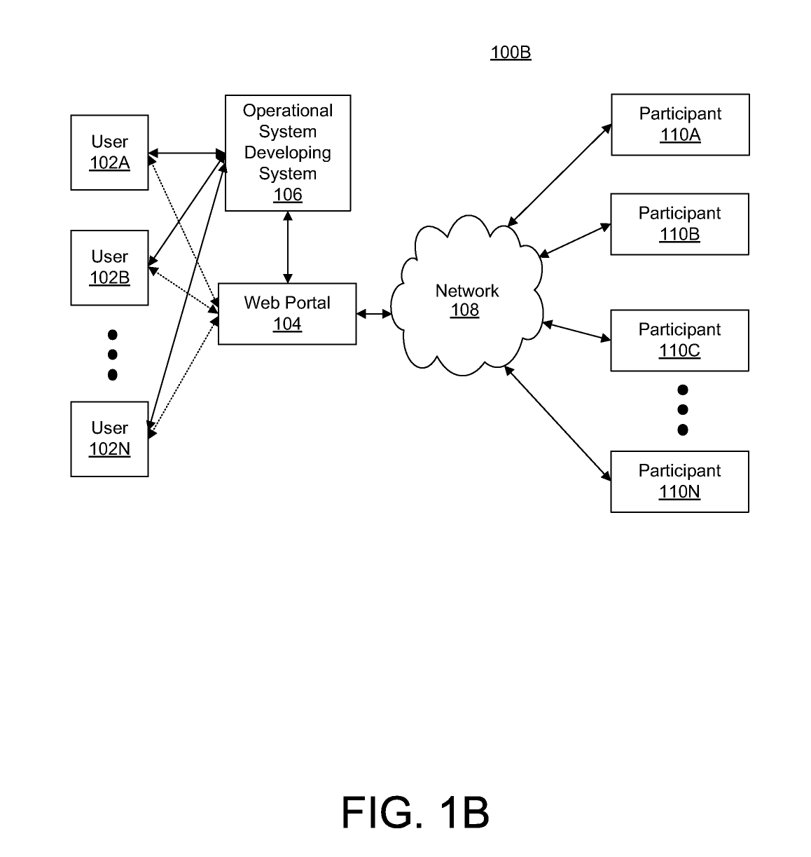

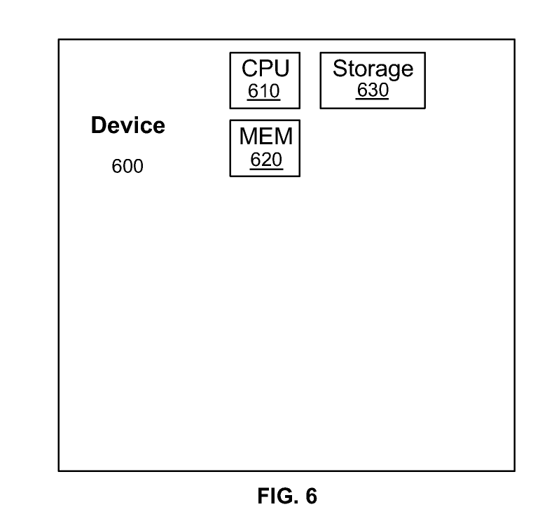

FIG. 1A illustrates an exemplary environment 100A, where various embodiments of the present disclosure may function. The environment 100A mainly includes four elements (other numbers may be used), one or more users 102A-102N, a web portal 104, an operational system developing system 106, a network 108, and one or more participants 110A-110N. Developing system 106 may be a computer or system such as shown in FIG. 6. The one or more users 102A-102N hereinafter may be referred as users 102 and the one or more participants 110A-110N may be referred as participants 110 without changing their meaning. Further, the participant 110 may refer to a single participant of the participants. Similarly, a user 102 may refer to a single user 102 of the users 102. The users 102 may interact with the participants 110 through network 108. The network 108 can include one or more networks, may include the Internet, and may be a wired network or a wireless network or a combination of these. The wireless network may use wireless technologies to provide connectivity among various devices. Examples of the wireless technologies include, but are not limited to, Wi-Fi, WiMAX, fixed wireless data, ZigBee, Radio Frequency 4 for Consumer Electronics network (RF4CE), Home RF, IEEE 802.11, 4G or Long Term Evolution (LTE), Bluetooth, Infrared, spread-spectrum, Near Field Communication (NFC), Global Systems for Mobile communication(GSM), Digital-Advanced Mobile Phone Service (D-AMPS). Examples of the wired network include, but are not limited to, Local Area Network (LAN), Metropolitan Area Network (MAN), Wide Area Network (WAN), and so forth. In an embodiment of the invention, the network 104 is or includes the Internet. A user or a participant may interact with or provide input to system 106 via for example a computer using a processor such as shown in FIG. 6.

The operational system developing system 106 is configured to develop an operational system by involving the multiple participants 110 connected to the network 108 (e.g., via a computer or terminal for example as shown in FIG. 6). Hereinafter, the operational system developing system 106 may be referred as developing system 106. The developing system 106 may be software, hardware, firmware or combination of these, and may be embodied in one or more devices such as a device shown in FIG. 6. The developing system 106 may distribute the development effort of an operational system such as a software system, among hundreds, thousands, or even larger number of participants 110, to shorten development cycle time, with much higher reliability. The developing system 106 may be configured to define a project along with a domain of the project and at least one set of rules such as formal development rules related to the domain of the project with the assistance or input from the users 102. The users 102 may use one or more electronic devices for defining the project. Examples of the electronic devices include, but are not limited to, computers, laptops, smart phones, tablet computers, and so forth (e.g., a device as shown in FIG. 6). The users 102 may define an objective, one or more functional requirements for the project, a problem domain of the project, and also various rules for developing the project. The problem domain defines the problem the project intend to solve and also a class of application of the project. In an embodiment of the present disclosure, the developing system 106 may be a software application running on the one or more electronic devices. Assistance from a user in defining a project or other tasks (e.g., decomposing a project, setting prices or compensation levels, etc.) may include user input, e.g., via user devices, and may include a system, e.g., system 106, receiving input from users. Defining a project may include a system such as system 106 defining a project using user input.

The developing system 106 then may decompose or divide the defined project into a number of tasks following a recursive up-down process with assistance or input from the users 102. When discussed herein, a task that has been decomposed from a task may be called a sub-task; a task may be discussed herein as a sub-task. Each of these tasks may include for example a task definition language, at least one associated test task, and multiple rules for performing the task. The tasks may also include more information which may be required to complete the task in an efficient manner. Other structures for tasks may be used. As with other tasks which may involve input or assistance from a user, such assistance or input may include a system, e.g., system 106, receiving input from users.

The users 102 then may publish these tasks, for example, on the network 108 through a web portal 104 or via another method. The web portal 104 can be a social networking website, such as but not limited to, Facebook, Twitter, MySpace, and so forth or an open source development platform. The users 102 may also publish or cause to be displayed a payment offer along with other information about the tasks. The other information may include, such as, but not limited to, the task definition language, the test task, the multiple rules associated with the tasks. In an embodiment, the payment offer can be zero. In such a case when the payment offer is zero, the participant performing the task does not get any payment for doing the task. The developing system 106 may offer, allocate, divide up and/or distribute these tasks to one or more participants 110. In an embodiment, the web portal 106 may allocate the one or more tasks to the participants based on one or more predefined criteria. The predefined criteria may include one or more of a skill-set of the participant, technology interests of the participant, an educational background of the participant, time availability, and so forth. In another embodiment, the developing system 106 or the web portal 104 may distribute or allocate the tasks to multiple participants with assistance from the one or more users 102. The users 102 may allocate the tasks based on the predefined criteria. Assistance from a participant in creating a task, etc., may include participant input, e.g., via participant devices (e.g., as shown in FIG. 6), and may include a system, e.g., system 106, receiving input from participants.

In another embodiment, the developing system 106 may allocate the plurality of published tasks to a number of participants 110 with assistance or input from the participants 110. The participants 110 connected to the network 108 may select one or more of these tasks (e.g., send input to system 106 re a selection) based on one or more parameters such as, but are not limited to, the payment offer, associated technology, a time deadline of the task, and so forth. Each of these participants 110 may select at least one task that he/she wants to perform. The developing system 106 may allocate the selected task to the participant 110 and locks the selected task until the selected task is completed or the participant has relinquished control from the selected task. Allocation or distribution may be done, for example, by sending the task or a description of the task to a participant via a network (e.g., network 108) and a terminal or computer such as shown in FIG. 6. A participant may complete the task (e.g., write software, debug software) using a device such as in FIG. 6. A participant may report on progress and send the completed product or task back to system 106 via a device such as in FIG. 6 and a network, e.g., network 108. Devices such as system 106 and devices used by users and participants may have structures and components different from those shown in FIG. 6, devices used by users and participants may differ from system 106.

The developing system 106 may also track the progress of each of the tasks based on a status of each of the tasks. The status of the tasks depicts a current stage or condition of the tasks. For example, the status of the task may be under process, testing, development, and so forth. The developing system 106 can visualize and verify that a task is assigned to only one participant until the time the task is either complete or returned incomplete from a participant 110 to whom the task was assigned initially. For example, system 106 may display or cause to be displayed (e.g., via a browser on a user device) a map or other display showing the different tasks and the status in such a way that a user can understand what portions of the project are completed, assigned under development, etc. (While Web browsers are discussed herein, other interfaces may be used). Since the process is in some embodiments recursive a user may zoom into or expand parts of the visualization to see the project and its details. The developing system 106 may receive the performed tasks from the participants 110. In one embodiment a task is marked as complete only when the task has been completed in an allocated time and tested properly based on its associated test task. The task may be considered as complete in one embodiment only when the task has passed a test based on the associated test task, and an outcome of a completed task may be one of the operational components. In one embodiment if the task is not tested or debugged properly then the developing system 106 may re-allocate this task to another participant or a second participant of the participants 110. In addition, if the task has one or more bugs or errors, then the developing system 106 may send the task back to the participant or first participant to whom it was assigned or allocated initially. As shown, the developing system 106 is a part of the web portal 104. But the developing system 106 may exist and function without being part of the web portal 104 as shown in FIG. 1B.

FIG. 1B shows an environment 100B, in accordance with another embodiment of the present disclosure. In the environment 100B, the developing system 106 is not part of the web portal 104. In some embodiments, the developing system 106 may be installed on a standalone device such as, but not limited to, a computer, a laptop, a smart phone, a tablet computer, and so forth. The one or more users 102 may interact with the developing system 106 through the network 108. In other embodiments, the developing system 106 may be installed on the electronic devices associated with the users 102.

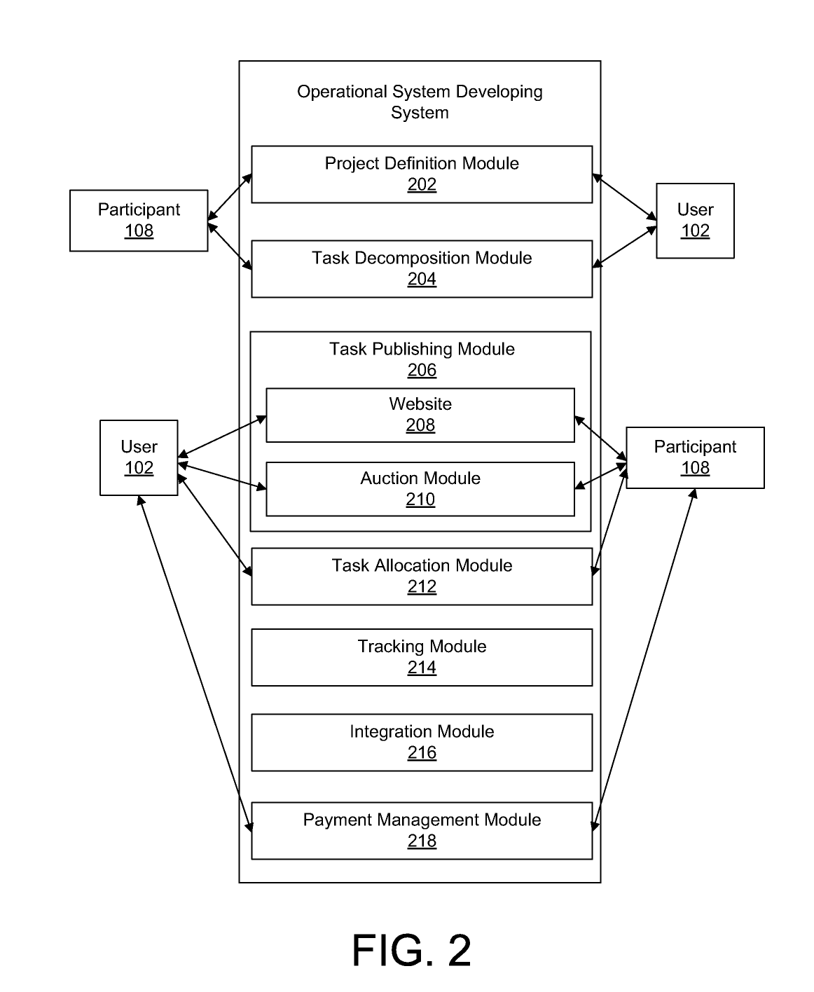

FIG. 2 illustrates exemplary components of the developing system 106 of FIG. 1, in accordance with an embodiment of the present disclosure. The developing system 106 includes a project definition module 202, a task decomposition module 204, a task publishing module 206, a task allocation module 212, a tracking module 214, an integration module 216, and a payment management module 218. The project definition module 202 may define the project along with a domain of the project and at least one set of rules such as formal development rules related to the domain of the project with assistance from the users 102. The problem domain defines the problem that the project intends to solve and also a class of application of the project. In an embodiment, the users 102 may define or help define the project by using the developing system 106 or providing input to system 106. The developing system 106 may be a software, hardware, firmware or combination of these. In an embodiment of the present disclosure, the developing system 106 may be a software application running on the one or more electronic devices of the users 102. For example, modules 202-218 may be executed by processor 610 (FIG. 6).

The task decomposition module 204 may be configured to decompose or divide the defined project into a number of tasks or sub-tasks in a recursive up-down process, possibly with assistance or input from the users 102. Each of these tasks may include a task definition language, at least one associated test task, and multiple rules for performing the task. The tasks may also include more information which may be required to complete the task in an efficient manner. The tasks and the project may be defined in human understandable and readable language such as, but not limited to, English. In an embodiment, the language may depend on the location of the users 102. The task decomposition module 204 is further configured to define a formal task definition or object interface language for each of the tasks. The task decomposition module 204 may also be configured to define an interface of each of tasks for communicating with other tasks. The task decomposition module 204 may further be configured to define the associated test task for each of the tasks for testing the tasks prior to integrating into the operational system. The project may be divided or decomposed until, for example, each of the tasks is too small to be decomposed further based on at least one of the task definition language and the multiple rules. Other measures of when to stop decomposing or dividing may be used. In an embodiment, the language used to define the tasks and the interfaces may enable the discovery of practically similar already defined or completed tasks when required in future. Therefore, these tasks will not require effort in future as no participant is required to create them. An outcome of a completed task is an operational component. Moreover, these operational components or tasks may be used directly when required later. The already done tasks may be stored in a database (not shown), in the electronic device or on a server (not shown) in the network 108. Further, the rules includes a module functionality language used as Element Definition Language, so that the one or more operational components developed or defined by completing the tasks are re-usable and searchable based on the descriptors and interfaces of the tasks. The task can be a decomposition task, a development task, a test task, or an integration task.

In one embodiment, the rules include a module functionality language used as Element Definition Language, so that the one or more operational components developed or defined by completing a tasks are re-usable and searchable based on the descriptors and interfaces of the tasks.

The task publishing module 206 may publish the multiple tasks on the network 108. Publishing may include, for example, distributing, displaying, causing to be displayed, or causing to be accessible via a search or a request to display, a task or information regarding a task, for example via a device such as that shown in FIG. 6. In one embodiment, when the developing system 106 is not part of the web portal, the developing system 106 may include, execute or operate a website 208. In such an embodiment, the website 208 may publish the tasks on the network 108. The website 208 may have an associated uniform resource locator (URL). The website 208 may be accessible by users and participants, who may interact with the website via a device such as shown in FIG. 6 to provide input, receive output, and accessed published items. The website 208 may publish the tasks for auction with assistance from the users 102 and the participants 110. The task publishing module 206 may include an auction module 210 for inviting one or more price auctions from the participants 110 for doing a task. The auction module 210 may be configured to receive one or more price auctions from the participants 110 for performing these tasks. The price auction can be zero in a preferred embodiment. The auction module 210 may further publish the price auctions with assistance from the participants 110 or the users 102.

The task allocation module 212 is configured to allocate, distribute and/or divide the published tasks to a number of participants 110 in the network based on one or more predefined criteria. The predefined criteria may include one or more of a skill-set of the participant, one or more technology interests of the participant, an educational background of the participant, and so forth. Each of these tasks may be allocated with assistance from the participants 110. Each of the participants 110 may selects at least one task that the participant 110 wants to perform. (e.g., via a website operated by system 106 and displayed on a user device). The task allocation module 212 then allocates the selected task to the participant 110, and locks or marks as locked the selected task until the selected task is either completed or the participant has relinquished control from the selected task. The task allocation module 212 marks or considers a task as complete only when the task has passed the test based on the associated test task. An outcome of a completed task is one of the operational components. In one embodiment, the tasks may be distributed or allocated to the participants 110 by using a Mechanical Turk system from Amazon.

The tracking module 214 is configured to verify that a task is allocated to only one participant of the participants 110 until the time the task is not complete or returned incomplete from the participant (or first participant) to whom it was assigned initially. Further, the tracking module 214 is configured to visualize the progress of each of the tasks based on a status of each of the tasks. For example, module 215 may display or cause to be displayed (e.g., via a browser on a user device) a map or other display showing the different tasks and the status in such a way that a user can understand what portions of the project are completed, assigned under development, etc. The status depicts the current condition of the task such as under process, testing, development, and so forth. The tracking module 214 is also configured to track the progress of project development, project decomposition and project integration based on the visualization of the progress of the tasks.

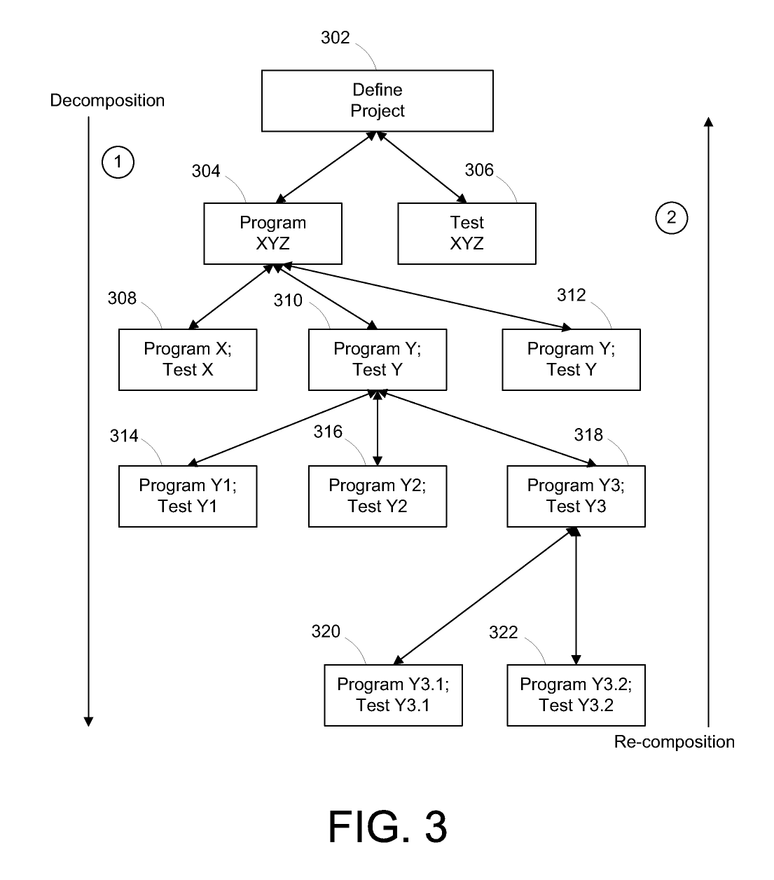

The participants 110 then send back (e.g., provide input to) the performed tasks to the developing system 106 which may receive the tasks, e.g., via network 108 and a device such as shown in FIG. 6. In an embodiment, a transceiver (not shown) may receive the completed or performed tasks from the participants 110. The participants 110 may be classified as first participants and second participants. The first participants may refer to the participants to whom one or more tasks are assigned initially. The second participants may refer to the participants to whom the tasks are re-allocated or re-assigned later. The tracking module 214 may check if the tasks were properly tested using the test task. The tracking module 214 may further check if there are any bugs or errors in the received tasks or operational components. If there are bugs then the integration module 216 sends that task(s) back to the first participant to whom the task was assigned before. If the first participant returned the task incomplete, then the task allocation module 212 re-allocates the returned task to another participant or second participant of the participants 110. Other levels of participants beyond second participants may be used. Once the tracking module 214 has checked the status of one or more tasks and marked them as complete, then operational components of the completed tasks are integrated in a down to up process. The tracking module 214 may also check if a completion date of a particular task is near or far and may take an appropriate step based on the check performed. For example, if the completion date for the task is near such as just two days away, then the payment management module 218 may change the payment offer of said task by increasing it to expedite the development of task. And if the completion date for a task is far for example, 10 days away then the payment management module 218 may decrease the payment offer of this task to slow down the development process of this task. Therefore, this way the development of the project may be controlled by the payment management module 218. The tracking module 214 is also configured to mark the one or more tasks as complete when the task is completed within the allocated time and the task is properly tested based on the associated test task. When one or more tasks are complete, the integration module 216 may re-combine or integrate the operational components of these completed tasks to form an operational system such as a software product. The integration module 216 may use a down to up process or approach for integrating the operational components for example as shown in FIG. 3 in detail.

After completion of the one or more tasks, the payment management module 218 may make the payments to the participants 110 based on the tasks performed by them and the price auction or the payment offer associated with the assigned tasks. The payment management module 218 may manage one or more payments corresponding to the tasks based on the visualization and verification of these tasks. In one embodiment payments are made only when it has been verified that the tasks are properly tested and do not include any errors. The payments may be done by using any conventional payment methods such as, a credit card, a debit card, net-banking, ACH, cash cards, Pay-Pal or any other payment method or secure payment method. Test tasks for every task may also be part of the tasks allocated to the participants 110. The task and associated test task may be matched for each of the received tasks prior to payment, so that payment is done only upon verification. The payment management module 218 is also configured to change the payment offer of one or more of the tasks either to expedite or slow down the development of the one or more tasks depending on an expected completion date of the project. For example, if the completion date of a task is one day away than the payment offer may be increased to expedite the process, and if the completion date for a task is ten days after then the payment offer may be decreased. Every task may have a time deadline for completing the task. If the tracking module 214 visualizes that a particular task is falling behind and cannot be completed within the allocated time deadline, then the payment management module 218 may increase the payment offer of this task to encourage the participant to put extra effort and complete the task within time. In some embodiments, the payment management module 218 may make the payment with assistance from the one or more users 102.

FIG. 3 illustrates a recursive process of task decomposition and integration for a software development project, in accordance with an embodiment of the present disclosure. As discussed with reference to FIGS. 1A-1B and FIG. 2, the task decomposition module 204 may decompose the defined project into multiple tasks for example until the task is small enough so that it cannot be decomposed further. The task decomposition module 204 may decompose the defined project into multiple tasks using a top-down process 1 as shown in FIG. 3. A defined project 302 is decomposed or divided into a task 304 or program XYZ and an associated task 306 or test task XYZ. The task 302 e.g. the program XYZ and task 306 e.g. test task XYZ may further be decomposed or broken down into three subtasks 308, 310, and 312 e.g. a Program X and an associated test task X, a Program Y and an associated task Y, and a Program task Z and an associated test task Z. Each of these subtasks 308-312 may be decomposed further into sub tasks. For example, the subtask Program Y can be divided into three subtasks 314, 316, and 318, e.g., a Program Y1 and an associated test task Y1, a Program Y2 and an associated task Y2, and a Program task Y3 and an associated test task Y3. Similarly, the program task 318 e.g. Program Y3 may further be decomposed into two subtasks 320, and 322 as Program Y3.1 and an associated test task Y3.1 and Program Y3.2 and an associated test task Y3.2 respectively. The decomposition process may be repeated for example until the project has been decomposed completely and each of the subtasks is small enough and cannot be decomposed further. These individual tasks then may be assigned to multiple participants 110 as discussed in FIG. 1A-1B. Different methods of decomposition or dividing tasks may be used.

After completion of these tasks, the operational components of these subtasks or tasks may be combined in a recursive manner following a down to up process 2. The operational components of subtasks 320 and 318 may be combined first, then of tasks 316, 314, and 312 are combined, then of 310,308, and 306 are combined to form an operational component. Finally this operational component is combined with operational component of task 304 to form the operational system. Different methods of combining tasks may be used.

For example, in a software development project, every stage of the recursive process may be shown or posted for example on the website 208 or a similar accessible bulletin or the web portal 104 that provides access for a large number of programmers or participants 110, to the various programming, graphic designs, or other project elements while ensuring that every element will be developed at least once or only once. For each programmed element or a task a test program (or test task) is defined and implemented to test every element (or task) and sub-element (subtask) before it is integrated. At this stage, a recursive down-up integration process is used to combine and test all the elements until we have an operational system.

The programming may use for example an Element Definition Language, so that elements will be searchable and re-usable. The business/project control mechanism may use a Price Tag (or payment offer) or kind of a price auction that may also be posted on every task or work element. By controlling the offered price on each of the tasks or work elements, the managers or the user 102 of the project can speed up or slow down specific parts of the process, and by doing that control the risk, the cost and the timing of the completion of the project. Systems such as the Mechanical Turk from Amazon may be used as a base platform for allocating and distributing the tasks and fees. The payment may be made to the programmers by using any pervasive type of payment mechanism potentially using commonly available credit cards or systems such as PayPal.

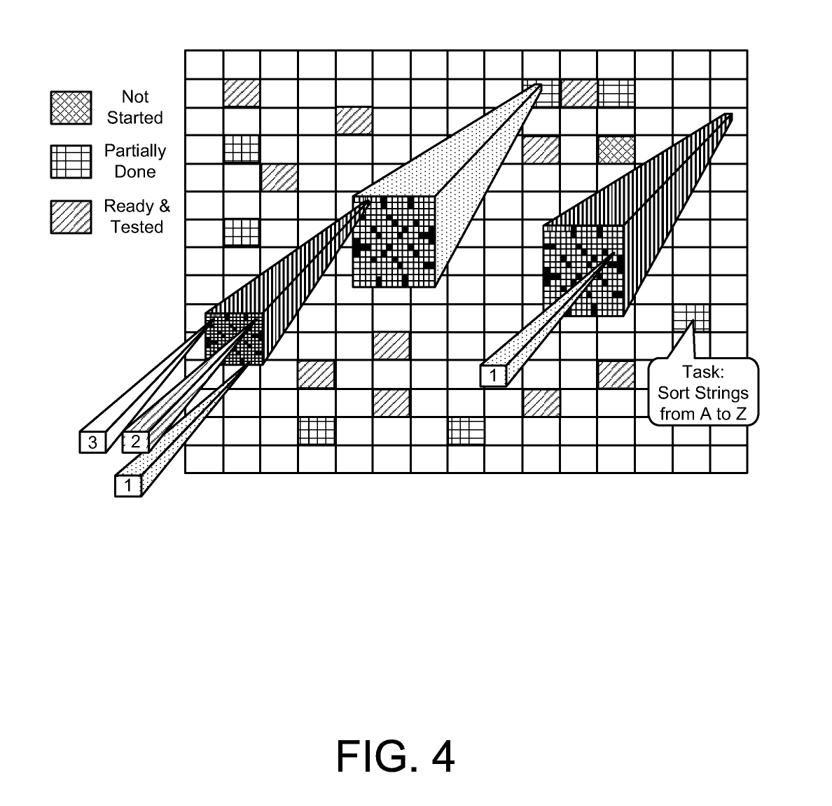

FIG. 4 illustrates an exemplary huge puzzle creation project, in accordance with an embodiment of the present disclosure. First the puzzle project is defined, as discussed with reference to FIG. 2, the project definition module 202 may define the project with assistance from the users 102. Then starting from the definitions of the characters on the edges, the project may be decomposed or cut into smaller puzzles while defining interfaces of each of the block to other blocks. As shown, each of the blocks refers to a task which can further be divided into subtasks. This process is repeated until the blocks are simple, and then the process (via participants) starts to create the specific word definitions that will compose those blocks, verifying each word definitions in the process, and each block. Thereafter, the smaller blocks may be integrated to form larger blocks moving up to larger and larger blocks integrating each block into the bigger picture, until the puzzle is complete. Some blocks are shown as ‘yet not started’, some are ‘partially done’ and few blocks are ‘ready and tested’ are ready for integration. Other labels or markers may be used. The payment management system 218 then may pay for ready and tested tasks or blocks by using any suitable method such as credit cards, net banking, and so forth.

Another example is the design or development of a product or machine, for example, a military tank. A starting assumption or information may be that there is a need for a cannon, a body, and wheels, which are three initial tasks. A participant is assigned the sub-task of defining or designing the cannon, and this person returns feedback or provides input that this is composed of a barrel and a trigger. The task of the trigger is assigned to a participant who provides input that triggers are composed of two parts and each one has a specific shape; at this point there is no more decomposition, and those two parts can be manufactured and integrated back into the cannon.

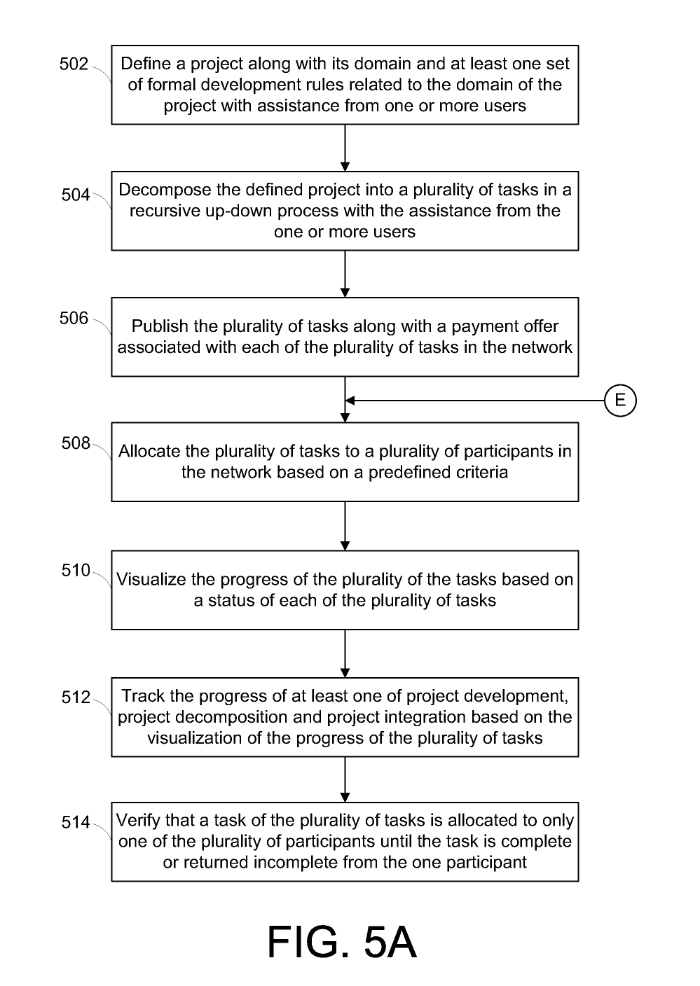

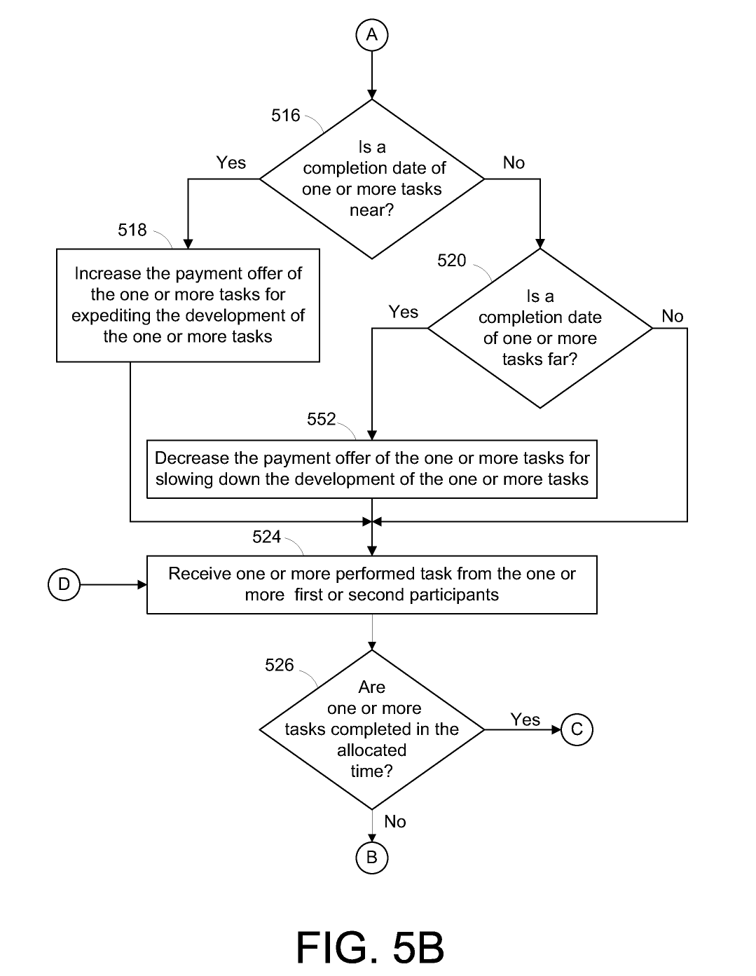

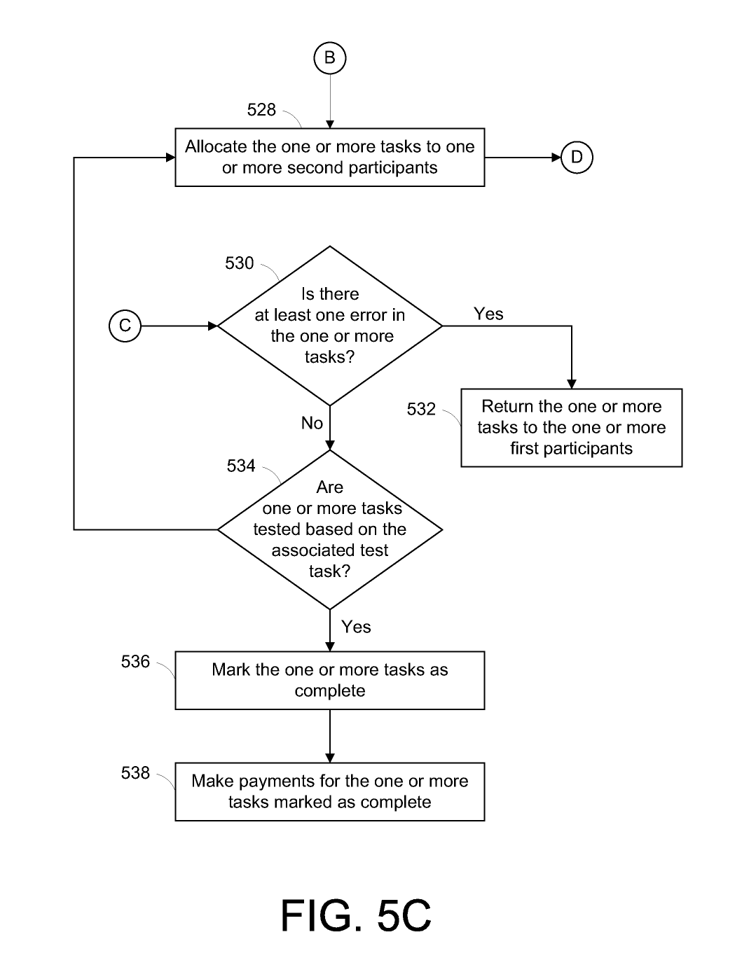

FIGS. 5A, 5B, 5C illustrate a flowchart for developing an optimized operational system, in accordance with an embodiment of the present disclosure. As discussed with reference to FIGS. 1A, 1B, and 2, the users 102 may define a project and decompose the project into multiple tasks and test tasks with the help of the developing system 106. The operational system may be developed by multiple participants 110 connected to the network 108.

At step 502, the task definition module 202 may define a project along with its domain and at least one set of rules such as formal development rules related to the domain of the project with assistance from the one or more users 102. At step 504, a task decomposition module 204 may decompose the defined project into a number of tasks in a recursive up-down process with the assistance from the one or more users 102. At step 506, a task publishing module 206 may publish the number of tasks along with a payment offer associated with each of the tasks in the network 108. In an embodiment, the web portal 104 may publish the tasks in the network 108. In another embodiment, the website 208 may publish the tasks in the network 108. At step 508, a task allocation module 212 may allocate the tasks to a number of participants 110 present in the network 108 based on one or more predefined criteria. The predefined criteria may include for example, one or more of a skill-set of the participant, one or more technology interests of the participant, an educational background of the participant, and/or other criteria. Each of these tasks may be allocated with assistance or input from the participants 110. For example, each of the participants 110 may select (e.g., by providing input to system 106) at least one task that the participant 110 wants to perform. The task allocation module 212 then allocates the selected task to the participant 110, and locks or marks for example as taken the selected task until the selected task is either completed or the participant 110 has relinquished control from the selected task. The task allocation module 212 may mark or consider a task as complete only when the task has passed the test based on the associated test task, further an outcome of a completed task is one of the operational components. In an embodiment, the tasks may be allocated to the participants 110 by using a Mechanical Turk system from Amazon.

At step 510, a tracking module 214 may visualize the progress of the tasks based on a status of each of the tasks. The status depicts or indicates the current condition of the task such as under process, testing, development, and so forth. Other status markers may be used. At step 512, the tracking module 214 may track the progress of at least one of project development, project decomposition and project integration based on the visualization of the progress of the tasks. At step 514, the tracking module 214 may verify that a task of the multiple tasks is allocated to only one of the participants 110 until the task is complete or returned incomplete from the one participant 110.

At step 516, the tracking module 214 may check if a completion date of one or more tasks near is near or not. If the completion date for a task is near for example it is just one day away, then step 518 is followed else control goes to step 520. At step 518, the payment management module 218 may increase the payment offer of the one or more tasks for expediting the development of the one or more tasks. At step 520, the tracking module 214 may check if the completion date of the one or more tasks is far or not. If the completion date of the one or more tasks is far, for example, twenty days away, then step 522 is followed. At step 522, the payment management module 218 may decrease the payment offer of the one or more tasks for slowing down the development of the one or more tasks. The tracking module 214 may decide whether the date is near or far by comparing the completion date with a predefined threshold value such as 10, 2, 4, 6, and so forth.

Thereafter, at step 524, the developing system 106 may receive the one or more performed tasks from the participants 110. The participants 110 may be classified as first participants and second participants. The first participants may refer to the participants to whom one or more tasks are assigned initially. The second participants may refer to the participants to whom the task was re-allocated or re-assigned later. At step 526, the tracking module 214 may check whether the received tasks have been completed in an allocated time assigned to these tasks. If not, then the control goes to step 528, else control goes to step 530. At step 528, the task allocation module 212 may allocate the one or more tasks which are not completed on time or returned incomplete to one or more second participants. After step 528, the control may go back to step 524.

When at step 526, the tasks are completed in the allocated time, step 530 is executed. At step 530, the tracking module 214 may check if there are any bugs or errors in the received task or operational components. If there are bugs then the integration module may send that task back to the first participant to whom the task was assigned before at step 532, else the control goes to step 534. At step 534, the tracking module 214 may check that the received tasks are properly checked based on their associated test tasks. If the received tasks are not properly tested then control goes to step 528, else step 536 is followed. At step 536, the tracking module 214 may mark the one or more tasks as complete. Then at step 538, the payment management module 218 may make the payments for the one or more tasks marked as complete. The payments may be done by using any conventional payment methods such as, a credit card, a debit card, net-banking, ACH, cash cards, pay-pal or any other secure payment method. As test tasks for every task is also part of the tasks allocated to the participants 110. The task and associated test task may be matched for each of the received tasks prior to payment, so that payment is done only upon verification. This may ensure that verification is done throughout the development process, and integration problems may be eliminated or reduced to a large extent.

The design is usually not the strongest part of any software project. Usually, schedules dictate that programming starts before a full design is completed. This may cause integration problems later on. A recursive method as disclosed in embodiments of the present invention may ensure that programming starts only on components that are fully designed from the top. Hence it ensures that every part of the program may be integrated back up to the component above it. The design itself can be implemented at the exact same recursive way. Another advantage of some embodiments of the disclosed systems and methods is the access to a large number or participants 110 which can be developer or programmers while reducing the need to reveal the essence of the project as a whole to many people, or even coordinate between the programmers.

Another advantage of embodiments of the disclosed systems and methods is that it may allow a hundreds or thousands of participants 110 to work in parallel on multiple tasks of a same project. This shortens the development cycle of the project to weeks instead of months. Yet another advantage may be that debugging of the whole system may not depend on a specific programmer. A problematic module may be re-posted for re-programming or for improving its efficiency by other programmer or returned to its original programmer or first participant for debugging or improvement. The participants may require signing a contract or agreement. Further, cost of development may not include non-efficient programmer's time as the payment can be contractually defined only for completed tasks. Embodiments may also help to overcome or eliminate the mental task switching inefficiencies of programmers, which is one of the major factors that reduces programming productivity. In some embodiments this is because each of the tasks is well defined and disjointed from the rest of the components.

Embodiments of the system and method also discloses a module functionality definition language which can allow reuse of code potentially without requiring human intervention, rather by matching similar descriptions and interfaces. Embodiments may be in line with the move to open source, code modularity, code reuse, Web-services, Simple Object Access Protocol (SOAP), Representational State Transfer (REST), and other methodologies. SOAP is a communication protocol. REST is an architecture style for designing networked applications.

Embodiments of the invention are described above with reference to block diagrams and schematic illustrations of methods and systems according to embodiments of the invention. It will be understood that each block of the diagrams and combinations of blocks in the diagrams can be implemented by computer program instructions. These computer program instructions may be loaded onto one or more general purpose computers, special purpose computers, or other programmable data processing translator to produce machines, such that the instructions which execute on the computers or other programmable data processing translator create means for implementing the functions specified in the block or blocks. Such computer program instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks.

A recursive decomposition process in one embodiment of the invention may produce or create a data tree structure that may enable the embodiment of the invention to preserve the integrity of a project for example by showing and preserving the dependencies of a certain task on other sub-tasks such that a change in one task or a sub-task can immediately indicate which dependent tasks are affected and need to be re-tested to ensure full test coverage of the project as a whole.

FIG. 6 is a schematic illustration of a system according to an embodiment of the present disclosure. FIG. 6 describes system 600, e.g. an operation system developing system 106, but the system shown in FIG. 6 may also be a user computer or terminal allowing a user or a participant to interact with system 106 (e.g., provide input, display a web page or other interface, etc.), or another device performing all or part of a method according to embodiments of the invention. System 600 may be a server, computer, terminal, workstation, laptop computer, smart phone, tablet computer, etc. System 600 may include one or more processor(s) or controller(s) 610, a memory 620, and a long term storage device 630. Memory 620 may store, e.g., instructions or software which when executed by controller 610 cause controller 610 to carry out embodiments of the invention, and/or data such as task data, user data, participant data, financial data, etc. Processor or controller 610 may include one or more processors. Long term storage device 630 may be for example, a disk drive, hard drive, etc.

While the invention has been described in connection with what is presently considered to be the most practical and various embodiments, it is to be understood that the invention is not to be limited to the disclosed embodiments, but on the contrary, is intended to cover various modifications and equivalent arrangements included within the spirit and scope of the appended claims. The invention has been described in the general context of computing devices, phone and computer-executable instructions, such as program modules, being executed by a computer. Generally, program modules include routines, programs, characters, components, data structures, etc., that perform particular tasks or implement particular abstract data types. A person skilled in the art will appreciate that the invention may be practiced with other computer system configurations, including hand-held devices, multiprocessor systems, microprocessor-based or programmable consumer electronics, network PCs, minicomputers, mainframe computers, and the like. Further, the invention may also be practiced in distributed computing worlds where tasks are performed by remote processing devices that are linked through a communications network. In a distributed computing world, program modules may be located in both local and remote memory storage devices.

Embodiments of the invention may include an article such as a computer or processor readable non-transitory storage medium, such as for example a memory, a disk drive, or a USB flash memory device encoding, including or storing instructions, e.g., computer-executable instructions, which when executed by a processor or controller, cause the processor or controller to carry out methods disclosed herein.

This written description uses examples to disclose the invention, including the best mode, and also to enable any person skilled in the art to practice the invention, including making and using any devices or systems and performing any incorporated methods. The patentable scope the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method for developing an optimized operational system in a network, the method comprising:
defining a project along with a domain of the project and at least one set of formal development rules related to the domain of the project with assistance from one or more users;
decomposing the defined project into a plurality of tasks in a recursive up-down process with the assistance from the one or more users, wherein each of the plurality of tasks comprises at least one of a task definition language, at least one associated test task, and a plurality of rules;
publishing the plurality of tasks along with a payment offer associated with each of the plurality of tasks in the network;
allocating the plurality of tasks to a plurality of participants in the network based on one or more predefined criteria; and
integrating a plurality of operational components into the operational system by using a recursive down-up integration process;
wherein the plurality of operational components are developed, by the plurality of participants, by completing the allocated tasks and testing each of the plurality of tasks.

2. The method of claim 1, wherein the plurality of tasks are allocated with assistance from the plurality of participants, further wherein each of the plurality of said participants selects at least one said task that the participant wants to perform, wherein said task is allocated to the participant, and wherein said task is locked until said task is complete or the participant relinquish control from said task.

3. The method of claim 1, wherein said task is considered as complete only when said task has passed the test based on the associated said test task, further wherein an outcome of a completed task is one of the operational components.

4. The method of claim 1, wherein decomposing the project into the plurality of tasks comprises:
defining an interface of each of the plurality of tasks for communicating with at least one other tasks of the plurality of tasks; and
defining the associated test task for each of the plurality of tasks for testing each of the tasks prior to integrating into the operational system;
wherein the project is decomposed such that each of the plurality of tasks is too small to be decomposed further based on at least one of the task definition language and the plurality of rules.

5. The method of claim 1, wherein each of the plurality of tasks is at least one of a decomposition task, a development task, a testing task, or an integration task.

6. The method of claim 1, comprising:
visualizing the progress of the plurality of the tasks based on a status of each of the plurality of tasks, wherein the status depicts the current condition of the task;
tracking the progress of at least one of project development, project decomposition and project integration based on the visualization of the progress of the plurality of tasks;
verifying that a task of the plurality of tasks is allocated to only one of the plurality of participants until the task is complete or returned incomplete from the one participant; and
changing a payment offer associated with one or more of the plurality of tasks for at least one of expediting or slowing down the development of the one or more tasks of the project depending on an expected completion date of the project.

7. The method of claim 6, wherein the payment offer is zero.

8. The method of claim 1 further comprising at least one of:
re-allocating a previously allocated task to another participant when a predefined condition is satisfied, wherein the predefined condition is satisfied when at least one of:
the task is not debugged properly; and
the task is not completed in an allocated time; and
returning one or more tasks having at least one error to at least one participant who performed the one or more tasks.

9. The method of claim 1, wherein publishing the plurality of tasks further comprises:
publishing the plurality of tasks through a web site in the network; and
inviting one or more price auctions from the plurality of participants for performing the plurality of tasks.

10. A method for developing an operational system with the help of a plurality of participants in a network, the method comprising:
defining a project along with a domain of the project and at least one set of formal development rules related to the domain of the project, wherein one or more users define the project in a language understandable by at least one of the plurality of participants or the one or more users;
decomposing the defined project into a plurality of tasks in a recursive up-down process with the assistance from the one or more users, wherein each of the plurality of tasks comprises at least one of a task definition language, at least one associated test task, and a plurality of rules, wherein the project is decomposed such that each of the plurality of tasks is too small to be decomposed further based on at least one of the task definition language and the plurality of rules;
publishing the plurality of tasks along with a payment offer associated with each of the plurality of tasks through a website in the network;
inviting price auctions, from the plurality of participants, for performing the plurality of tasks;
allocating the plurality of tasks to the plurality of participants in the network based on at least one of a predefined criteria and the received price auctions; and
integrating a plurality of operational components into the operational system by using a recursive down-up integration process;
wherein the plurality of operational components are developed, by the plurality of participants, by completing the allocated tasks and testing each of the plurality of tasks.

11. The method of claim 10, wherein the plurality of tasks are allocated with assistance from the plurality of participants, further wherein each of the plurality of said participants selects at least one said task that the participant wants to perform, wherein said task is allocated to the participant, and wherein said task is locked until said task is complete or the participant relinquish control from said task.

12. The method of claim 10, wherein decomposing the project into the plurality of tasks further comprises:
defining an interface of each of the plurality of tasks for communicating with other tasks of the plurality of tasks; and
defining the associated test task for each of the plurality of tasks for testing each of the tasks prior to integrating into the operational system.

13. The method of claim 10, wherein each of the plurality of tasks is at least one of a decomposition task, a development task, a testing task, or an integration task.

14. The method of claim 10, wherein the payment offer is zero.

15. The method of claim 22 further comprising at least one of:
re-allocating a previously allocated task to another participant when a predefined condition is satisfied, wherein the predefined condition is satisfied when at least one of:
the task is not debugged properly; and
the task is not completed in an allocated time; and
returning one or more tasks having at least one error to at least one participant who performed the one or more tasks.

16. A system for developing an optimized operational system in a network, the system comprising:
a project definition module configured to define a project along with a domain of the project and at least one set of formal development rules related to the domain of the project with assistance from one or more users;
a task decomposition module configured to decompose the defined project into a plurality of tasks in a recursive up-down process with the assistance from the one or more users, wherein each of the plurality of tasks comprises at least one of a task definition language, at least one associated test task, and a plurality of rules;
a task publishing module configured to publish a plurality of tasks along with a payment offer associated with each of the plurality of tasks in the network;
a task allocation module configured to allocate the plurality of tasks to a plurality of participants in the network based on one or more predefined criteria; and
an integration module configured to integrate a plurality of operational components into the operational system by using a recursive down-up integration process;
wherein the plurality of operational components are developed, by the plurality of participants, by completing the allocated tasks and testing each of the plurality of tasks.

17. The system of claim 16, wherein the task decomposition module is further configured to:
define an interface of each of the plurality of tasks for communicating with other tasks of the plurality of tasks; and
define the associated test task for each of the plurality of tasks for testing each of the tasks prior to integrating into the operational system;
wherein the project is decomposed such that each of the plurality of tasks is too small to be decomposed further based on at least one of the task definition language and the plurality of rules.

18. The system of claim 16, wherein each of the plurality of tasks is at least one of a decomposition task, a development task, a testing task, or an integration task.

19. The system of claim 16, wherein the payment offer is zero.

20. The system of claim 16, wherein the task allocation module is further configured to:
re-allocate a previously allocated task to another participant when a predefined condition is satisfied, wherein the predefined condition is satisfied when at least one of:
the task is not debugged properly; and
the task is not completed in an allocated time; and
return one or more tasks having at least one error to at least one participant who performed the one or more tasks.
